(19) United States
(12) Patent Application Publication
(10) Pub. No.: US 2024/0361539 A1
(43) Pub. Date: Oct. 31, 2024

(54) OPTICAL COMMUNICATION CABLE

(71) Applicant: NITTO DENKO CORPORATION, Osaka (JP)

(72) Inventors: Ryuji KISHI, Osaka (JP); Naoto KONEGAWA, Osaka (JP); Ryoya UMEYAMA, Osaka (JP); Seiki TERAJI, Osaka (JP)

(73) Assignee: NITTO DENKO CORPORATION, Osaka (JP)

(21) Appl. No.: 18/629,035

(22) Filed: Apr. 8, 2024

(30) Foreign Application Priority Data
Apr. 28, 2023 (JP) 2023-075119

(51) Int. Cl. G02B 6/38

(52) U.S. Cl. CPC G02B 6/3889

(57) ABSTRACT

The optical communication cable includes an optical cord, a connector, a first housing, a second housing, and a resin for fixing the optical cord. An end portion of the optical cord for connection to the connector has a first end region and a second end region. A tip portion of the plastic optical fibers in the first end region is connected to the connector. The resin is disposed so as to be in contact with the end portion of the optical cord and the second housing. Expression is satisfied:

$$t 1 \leq t 2 + 5 \qquad ( 1 )$$

where t1 is the coefficient of linear expansion of the resin and t2 is the coefficient of linear expansion of the plastic optical fibers.

### TECHNICAL FIELD

The present disclosure relates to an optical communication cable and, more particularly, to an optical communication cable with excellent high-temperature and high-humidity properties which suppresses the occurrence of cracking in a plastic optical fiber.

### DESCRIPTION OF THE RELATED ART

In recent years, optical communication cables capable of transmitting large amounts of information to electronic devices and the like have been widely used. In such an optical communication cable, an optical cord having a plastic optical fiber (referred to hereinafter as a “POF” in some cases) or the like is typically connected to an opto-electric hybrid board present in a housing (case) of an opto-electric compound transmission module, and an end portion of the optical cord and the housing (case) are fixed with an adhesive for the purpose of maintaining the connection (as disclosed, for example, in Japanese Published Patent Application No. 2013-231896).

However, as a result of further reductions in weight and thickness of opto-electric compound transmission modules, it has been found that there is a danger of cracking in the POF disposed near the housing (case) when an environmental test (high temperature and high humidity) is conducted on optical communication cables including such opto-electric compound transmission modules.
Patent Literature 1: Japanese Published Patent Application No. 2013-231896

### SUMMARY

It is therefore an object of the present disclosure to provide an optical communication cable with excellent high-temperature and high-humidity properties in which the occurrence of cracking in a POF in an optical cord is suppressed even under high-temperature and/or high-humidity conditions.

As a result of diligent studies in view of the foregoing, the present inventors have directed attention toward the fact that, when exposed to high temperature and/or high humidity, an adhesive that fixes an end portion of an optical cord, a housing (in other words, a case), and the like is thermally expanded to apply stress to a POF of the optical cord, thereby causing cracking in the POF of the optical cord. Then, the present inventors have found that the application of excessive stress to the optical cord is suppressed by investigating the physical properties of the adhesive and the POF of the optical cord to complete the present disclosure.

Specifically, the present disclosure has the following aspects.
[1] An optical communication cable comprising: an optical cord including a POF and a covering layer provided around the POF; a connector for connection to the POF of the optical cord; a first housing disposed on a first surface side of the connector; a second housing disposed on a second surface side of the connector; and a resin for fixing the optical cord in a case formed by combining the first housing and the second housing, wherein an end portion of the optical cord for connection to the connector has a first end region where the covering layer is not formed and the POF is exposed, and a second end region where the covering layer is formed and the POF is not exposed, wherein a tip portion of the POF in the first end region is connected to the connector, wherein the resin is disposed so as to be in contact with the end portion of the optical cord and the second housing, and wherein Expression (1) is satisfied:

$$t 1 \leq t 2 + 5 \qquad ( 1 )$$

where t1 is the coefficient of linear expansion of the resin and t2 is the coefficient of linear expansion of the POF.
[2] The optical communication cable according to the aspect [1], wherein the coefficient of linear expansion of the POF is in the range of 50 to 80 ppm/° C.
[3] The optical communication cable according to the aspect [1] or [2], wherein the resin is disposed so as to be also in contact with the first housing.
[4] The optical communication cable according to any one of the aspects [1] to [3], wherein the resin is a resin having an epoxy group.
[5] The optical communication cable according to any one of the aspects [1] to [4], wherein the end portion of the optical cord has a length in the range of 4 to 8 mm.
[6] The optical communication cable according to any one of the aspects [1] to [5], wherein the first end region of the end portion of the optical cord has a length in the range of 1 to 4 mm.
[7] The optical communication cable according to any one of the aspects [1] to [6], wherein the resin is disposed so as to be also in contact with the first surface of the connector, and wherein a pedestal for fixing the position of the connector is provided between the second housing and the connector.

The present disclosure sets the coefficient of linear expansion (t2) of the POF of the optical cord and the coefficient of linear expansion (t1) of the resin disposed so as to be in contact with the second housing to satisfy Expression (1) described above. This reduces the influence of the expansion of the resin under high-temperature and/or high-humidity conditions to suppress the occurrence of cracking in the POF.

### BRIEF DESCRIPTION OF THE DRAWINGS

FIG. 1 is a perspective view showing the external appearance of principal parts of an optical communication cable according to one preferred embodiment of the present disclosure.

FIG. 2 is an exploded perspective view showing the configuration of the principal parts of the optical communication cable according to the one preferred embodiment of the present disclosure.

FIG. 3 is a partial sectional view illustrating an internal structure of the principal parts of the optical communication cable according to the one preferred embodiment of the present disclosure.

FIG. 4 is a sectional view taken along a line I-I of FIG. 3 and illustrating an internal structure of an optical cord for use in the optical communication cable shown in FIG. 3.

FIGS. 5 to 8 are partial sectional views illustrating internal structures of the principal parts of the optical communication cable according to the one preferred embodiment of the present disclosure.

FIG. 9A is a perspective view illustrating an internal configuration of an analytical model.

FIG. 9B is a top plan view of the internal configuration of the analytical model.

FIG. 9C is a perspective view illustrating an internal structure of an optical cord used in the analytical model.

FIG. 10A-1 is a perspective view showing a state of disposition of resin in the analytical model.

FIG. 10A-2 is a view of the analytical model of FIG. 10A-1 as seen from the connector side.

FIG. 10A-3 is a schematic sectional view illustrating the structure of the analytical model of FIG. 10A-1.

FIG. 10B-1 is a perspective view showing a state of disposition of the resin in the analytical model.

FIG. 10B-2 is a view of the analytical model of FIG. 10B-1 as seen from the connector side.

FIG. 10B-3 is a schematic sectional view illustrating the structure of the analytical model of FIG. 10B-1.

FIG. 11A-1 is a perspective view showing a state of disposition of the resin in the analytical model.

FIG. 11A-2 is a view of the analytical model of FIG. 11A-1 as seen from the connector side.

FIG. 11A-3 is a schematic sectional view illustrating the structure of the analytical model of FIG. 11A-1.

FIG. 11B-1 is a perspective view showing a state of disposition of the resin in the analytical model.

FIG. 11B-2 is a view of the analytical model of FIG. 11B-1 as seen from the connector side.

FIG. 11B-3 is a schematic sectional view illustrating the structure of the analytical model of FIG. 11B-1.

FIG. 12A is a view showing the deformation and stress distribution of POFs in experimental example 1.

FIG. 12B is a view showing the deformation and stress distribution of the POFs in experimental example 5.

FIG. 12C is a view showing the deformation and stress distribution of the POFs in experimental example 6.

FIG. 13 is a perspective view illustrating an internal configuration of the analytical model of experimental example 8, with portions dispensed with.

FIG. 14 is a graph showing the results of calculation of longitudinal stress of the POFs in experimental examples and a reference example together.

FIGS. 15 and 16 are graphs showing the results of simulation of lower stress of the POFs from a relationship between the distance from the connector and the coefficient of linear expansion.

FIG. 17 is a graph showing the lower stress at a distance of 4.3 mm from the connector versus different coefficients of linear expansion of resin.

FIG. 18A is a view showing the deformation and stress distribution of the POFs as seen in a lateral direction when a resin with a coefficient of linear expansion of 35 is used.

FIG. 18B is a view showing the deformation and stress distribution of the POFs as seen from above when the resin with a coefficient of linear expansion of 35 is used.

FIG. 19A is a view showing the deformation and stress distribution of the POFs as seen in the lateral direction when a resin with a coefficient of linear expansion of 85 is used.

FIG. 19B is a view showing the deformation and stress distribution of the POFs as seen from above when the resin with a coefficient of linear expansion of 85 is used.

FIG. 20A is a view showing the deformation and stress distribution of the POFs as seen in the lateral direction when a resin with a coefficient of linear expansion of 0 is used.

FIG. 20B is a view showing the deformation and stress distribution of the POFs as seen from above when the resin with a coefficient of linear expansion of 0 is used.

FIG. 21 is a graph showing the results of simulation of upper stress of the POFs from a relationship between the distance from the connector and the coefficient of linear expansion.

FIG. 22 is a graph showing the upper stress at a distance of 4.3 mm from the connector versus different coefficients of linear expansion of resin.

### DESCRIPTION OF THE PREFERRED EMBODIMENTS

The present disclosure will be described hereinafter based on an exemplary preferred embodiment of the present disclosure. However, the present disclosure is not limited to the following preferred embodiment.

In the present disclosure, the expression “not less than J” (J is any number) or “not greater than K” (K is any number) includes the meaning of “preferably greater than J” or “preferably less than K”.

Also, in the present disclosure, “J and/or K (J and K each represent any configuration)” means at least one of J and K, and means three combinations: J only, K only, and J and K.

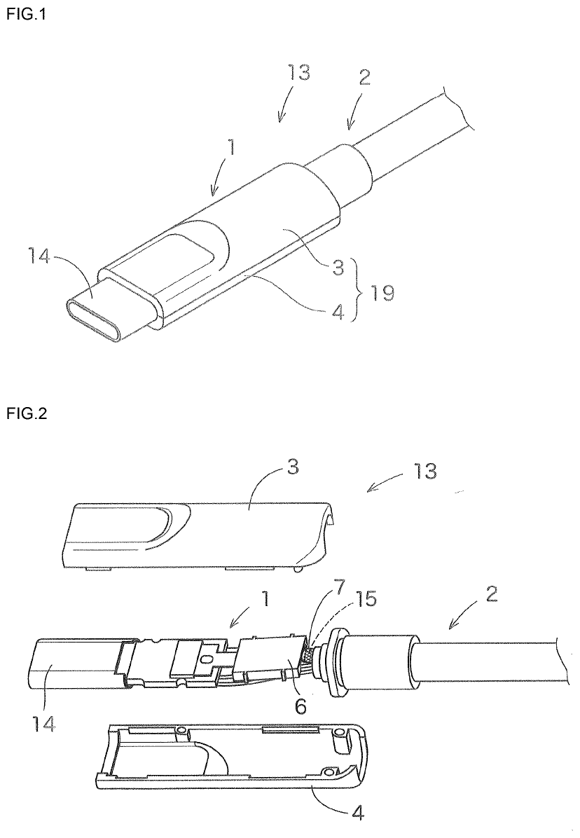

FIG. 1 is a perspective view showing the external appearance of an optical communication cable 13 according to one preferred embodiment of the present disclosure. FIG. 2 is an exploded perspective view showing the configuration of this optical communication cable 13.

The optical communication cable 13 of the present disclosure converts light outputted from a hybrid cable 2 into electricity to input the electricity to an electrical device not shown, and converts electricity outputted from an electrical device not shown into light to input the light to the hybrid cable 2.

In FIGS. 1 and 2, the reference numeral 14 designates a plug. Examples of the plug include a Type-C plug and an HDMI® plug.

In the optical communication cable 13 of the present disclosure, the hybrid cable 2 is fixed in a case 19 by bonding a second housing 4 to an optical cord 5 of the hybrid cable 2 and a connector 6 with a resin 7 at a connection between the optical cord 5 and the connector 6.

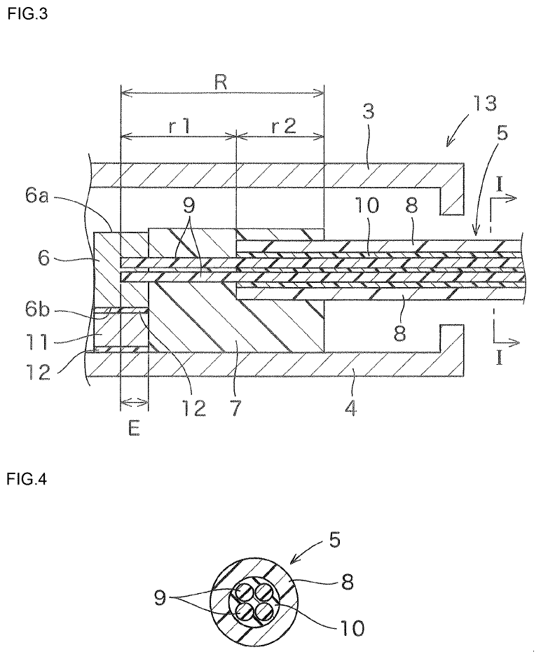

Thus, as shown in FIG. 3, the optical communication cable 13 of the present disclosure includes: the optical cord 5 having POFs 9 and a covering layer 8 provided around the POFs 9; the connector 6 for connection to the POFs 9 of the optical cord 5; a first housing 3 disposed on a first surface 6a side of the connector 6; the second housing 4 disposed on a second surface 6b side of the connector 6; and the resin 7 for fixing the optical cord 5 in the case 19 (with reference to FIG. 1) formed by combining the first housing 3 and the second housing 4.

An end portion R of the optical cord 5 for connection to the connector 6 has a first end region r1 where the covering layer 8 is not formed and the POFs 9 are exposed, and a second end region r2 where the covering layer 8 is formed and the POFs 9 are not exposed. A tip portion E of the POFs 9 in the first end region r1 is connected to the connector 6. The resin 7 is disposed so as to be in contact with the end portion R of the optical cord 5 and the second housing 4.

Details of these configurations will be described below.

### <Optical Cord>

The optical cord 5 includes the POFs 9, a tensile strength fiber 10 disposed around the POFs 9, and the covering layer 8 disposed outside the tensile strength fiber 10, as shown in FIG. 4 in cross section orthogonal to the longitudinal direction of the optical cord 5.

The POFs 9 are typically made of resins with different refractive indices for a core and a cladding. Examples of the material of the core include highly transparent methacrylic resin and quartz. Examples of the material of the cladding include fluororesin and epoxy resin.

In this manner, the POFs 9 are typically made of different resins for the core and the cladding. The core makes up the majority of the POFs 9.

For this reason, the physical properties of the core are used as the physical properties of the POFs 9 in the present disclosure.

The POFs 9 have a diameter preferably in the range of 200 to 400 μm, more preferably in the range of 210 to 390 μm, and further preferably in the range of 220 to 380 μm from the viewpoints of optical connection and strength.

The POFs 9 have a coefficient of linear expansion preferably in the range of 0 to 80 ppm/° C., further preferably in the range of 0 to 70 ppm/° C., and more preferably in the range of 0 to 60 ppm/° C. from the viewpoint of light intensity.

Examples of the tensile strength fiber 10 disposed around the POFs 9 include aramid fibers and tinsel wire from the viewpoint of tensile resistance.

Examples of the material of the covering layer 8 disposed outside the tensile strength fiber 10 include ionomer resin and polyvinyl chloride (PVC) from the viewpoints of hardness, heat resistance, and flame retardancy.

The end portion R of the optical cord 5 has a length preferably in the range of 4 to 8 mm, and more preferably in the range of 4 to 6 mm from the viewpoint of the strength of the optical communication cable.

The first end region r1 of the end portion R has a length preferably in the range of 1 to 4 mm, and more preferably in the range of 2 to 4 mm from the viewpoint of connection to the connector 6.

The tip portion E of the POFs 9 in the first end region r1 is connected to the connector 6, with the optical axes thereof aligned.

### <Connector>

The connector 6 for connection to the POFs 9 is typically made of polyphenylene sulfide (PPS), and has the function of facilitating the optical connection between an opto-electric hybrid board and the fibers.

### <First and Second Housings>

The first housing 3 disposed on the first surface 6a side of the connector 6 is used in combination with the second housing 4 (disposed on the second surface 6b side of the connector 6) which pairs up with the first housing 3 to form the generally box-shaped case 19 for housing the optical cord 5, the connector 6, and the like (with reference to FIG. 1).

The first housing 3 and the second housing 4 (referred to hereinafter as “the first housing 3 and the like” in some cases) are preferably made of a material having as high a thermal conductivity as possible in consideration of a heat dissipation effect, and especially a material having a thermal conductivity of not less than 50 W/mK.

The first housing 3 and the second housing 4 are more preferably made of metal from the viewpoints of being high in thermal conductivity and strength and capable of both having the heat dissipation effect and protecting the interior (a photoelectric conversion part 15 and the like). Specific examples of the metal material include aluminum, copper, silver, zinc, nickel, chromium, titanium, tantalum, platinum, gold, and their alloys (red brass, stainless steel, and the like). These may be used either alone or in combination. Also, the first housing 3 and the like may be plated or otherwise surface treated from the viewpoints of surface protection and aesthetics.

The first housing 3 and the like have a thickness preferably in the range of 0.1 to 0.6 mm, and more preferably in the range of 0.2 to 0.5 mm in consideration of the balance between the heat dissipation effect and weight reduction.

### <Resin>

The resin 7 for fixing the optical cord 5 in the case 19 formed by combining the first housing 3 and the second housing 4 together is disposed so as to be in contact with the end portion R of the optical cord 5 and the second housing 4, as shown in FIG. 3.

In the present disclosure, the coefficient of linear expansion (t1) of the resin 7 and the coefficient of linear expansion (t2) of the POFs 9 are designed to satisfy Expression (1).

$$t 1 \leq t 2 + 5 \qquad ( 1 )$$

The coefficients of linear expansion (t1) and (t2) that satisfy Expression (1) reduce the influence of the expansion of resin under high-temperature and/or high-humidity conditions to suppress the occurrence of cracking in the POFs 9 housed in the case 19.

The coefficient of linear expansion (t1) of the resin 7 is preferably in the range of 35 to 70 ppm/° C., further preferably in the range of 40 to 68 ppm/° C., and more preferably in the range of 45 to 65 ppm/° C. from the viewpoint of stress. The coefficient of linear expansion (t1) of the resin 7 may be the same as that of the POFs 9.

The thermal conductivity (W/mK) of the resin 7 is preferably in the range of 0.1 to 3 W/mK, and more preferably in the range of 0.1 to 1 W/mK from the viewpoint of excellent balance between adhesion and heat resistance.

Considering these factors, epoxy resin and acrylic resin, for example, are preferable as the resin 7. Especially, epoxy resin is preferably used because of its excellent combination with the POFs 9.

The resin 7 may be disposed not only as shown in FIG. 3 but also as shown in FIG. 5, for example, because the resin 7 is disposed to fix the optical cord 5 in the case 19.

FIG. 5 shows an example in which the resin 7 is disposed so as to be also in contact with the first housing 3. This disposition tends to further suppress the expansion of the POFs 9. However, it is necessary to carefully select the resin to be used because the expansion of the resin 7 might break the first housing 3 and the second housing 4 (the case 19) under high-temperature and/or high-humidity conditions.

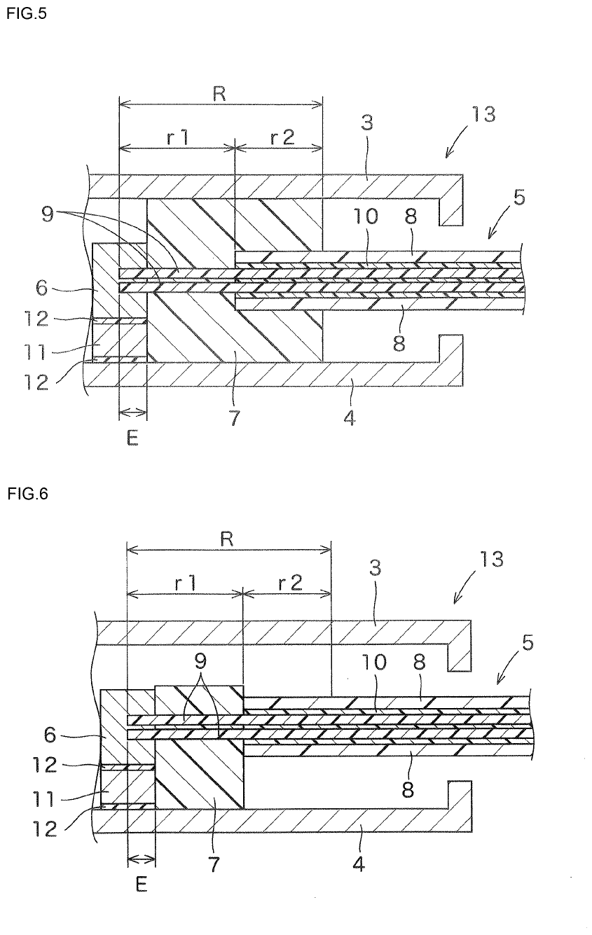

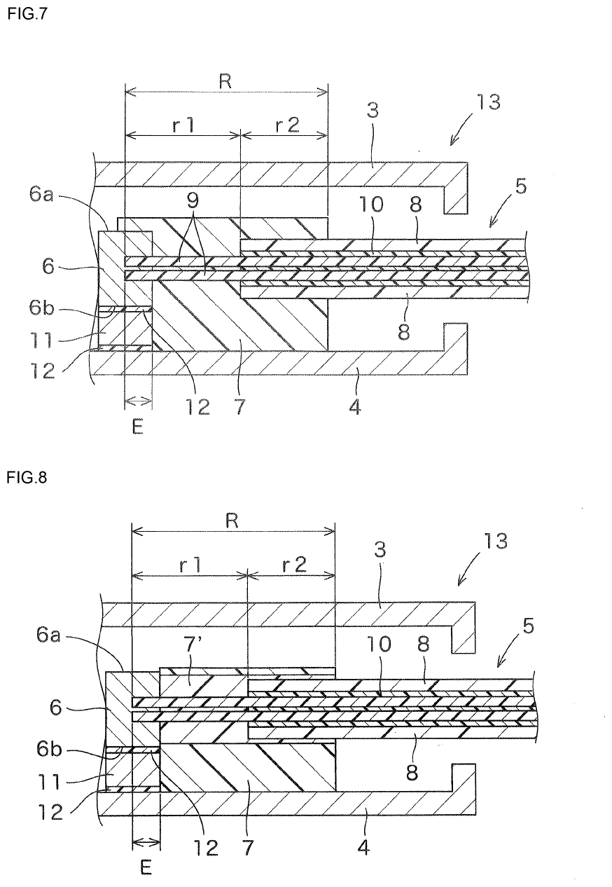

The resin 7 may also be disposed as shown in FIG. 6.

FIG. 6 shows an example in which only part of the end portion R of the optical cord 5 which is in the first end region r1 is disposed so as to be in contact with the resin 7. This disposition tends to achieve excellent weight reduction because the optical cord 5 is fixed using a small amount of resin.

The resin 7 may also be disposed as shown in FIG. 7.

FIG. 7 shows an example in which the resin 7 is disposed so as to be also in contact with the first surface 6a (the surface facing the first housing 3) of the connector 6. This disposition tends to achieve excellent durability because the connector 6 is fixed with reliability while being positioned.

At this time, it is preferable to provide a pedestal 11 between the connector 6 and the second housing 4. The provision of the pedestal 11 tends to make it easier to fix the connector 6 in a position where the connector 6 is easily connected to the POFs 9.

Preferably, the pedestal 11 is capable of fixing the POFs 9 at a distance from the second housing 4. The material of the pedestal 11 is not particularly limited. However, the pedestal 11 is preferably made of the same material as the second housing 4 because this makes it easier to calculate the stress inside the case 19.

The pedestal 11 may be formed integrally with the second housing 4, for example, or may be separately prepared and adhesively fixed to the second housing 4. It is preferable to form the pedestal 11 by preparing the pedestal 11 separately from the second housing 4 and adhesively fixing the pedestal 11 to the second housing 4 because this makes it easy to change the shape according to the design.

Further, the resin 7 may be disposed as shown in FIG. 8.

FIG. 8 shows an example in which two types of resins with different properties are used as the resin 7. Specifically, a resin 7′ covering the end portion R of the optical cord 5 and the resin 7 disposed in other locations have different properties. The use of multiple resins with different properties as the resin 7 tends to achieve excellent connection strength of the optical cord 5.

The coefficient of linear expansion (t1) of the resin 7 used in Expression (1) shall be the coefficient of linear expansion of the resin with the largest resin amount among the multiple resins with different properties. If the resin amounts of the multiple resins are equivalent, the coefficient of linear expansion of the resin with the higher coefficient of linear expansion shall be used as the coefficient of linear expansion (t1) of the resin 7 in Expression (1).

The optical communication cable 13 of the present disclosure is manufactured, for example, in a manner to be described below. First, an opto-electric compound transmission module 1 made of stainless steel and polyimide or the like is prepared. The pedestal 11 is attached, as necessary, in a predetermined position in the second housing 4, with an adhesive layer 12 therebetween, and accommodates the opto-electric compound transmission module 1. Then, the optical cord 5 contained in the hybrid cable 2 is connected to the connector 6 provided in the opto-electric compound transmission module 1, and the resin 7 is disposed so as to be in contact with the end portion R of the optical cord 5 and the second housing 4. This provides the optical communication cable 13.

The hybrid cable 2 generally has interconnect lines such as copper lines for supplying power in addition to the optical cord 5.

The optical communication cable 13 of the present disclosure is excellent in high-temperature and high-humidity properties because the occurrence of cracking in the POFs 9 in the optical cord 5 is suppressed even under high-temperature and/or high-humidity conditions.

### EXAMPLES

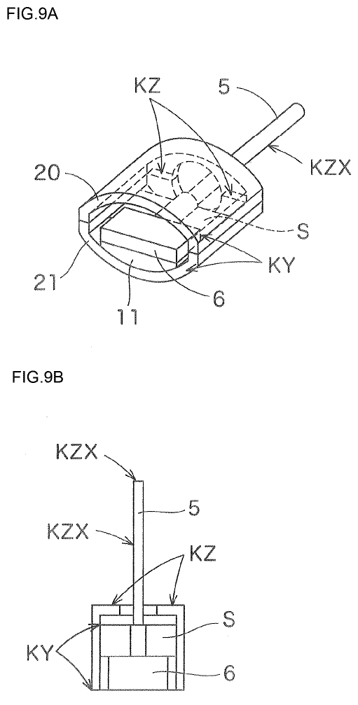

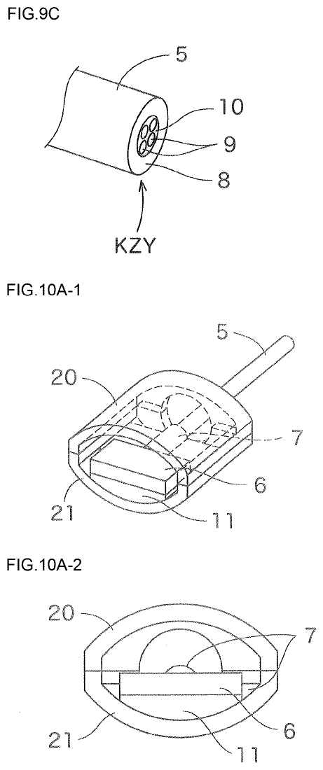

An analytical model shown in FIGS. 9A to 9C was created for investigation of the stress relationship between the optical cord 5 and the resin 7 for fixing the optical cord 5 in an optical communication cable.

The analytical model includes an upper housing 20, a lower housing 21, the connector 6, the optical cord 5, and the pedestal 11. The optical cord 5 includes the POFs 9, the tensile strength fiber 10, and the covering layer 8. The optical cord 5 and the connector 6 are connected to each other. The resin 7 is used to fix the optical cord 5 to the lower housing 21. The pedestal 11 is made of the same material as the lower housing 21, and is attached to the lower housing 21 with the use of an acrylic adhesive (with the adhesive layer 12 therebetween).

In the analytical model, Z constraints are placed at locations indicated by arrows KZ, ZX constraints are placed by the covering layer 8 at locations indicated by arrows KZX, and Y constraints are placed by an end portion of the connector 6 and an end portion of the resin 7 opposite the connector 6 at locations indicated by arrows KY, as shown in FIGS. 9A to 9C.

FIG. 9C shows a cross section of an end portion of the optical cord 5 shown in FIGS. 9A and 9B. ZX constraints are also placed on this cross section. However, this cross section is free in the Y direction.

The components of the analytical model are made of materials listed in TABLE 1 below.

The physical properties of the materials are also listed in TABLE 1 below.

TABLE 1

| | | | | | Coefficient |
|---|---|---|---|---|---|
| | | | | | of linear |
| Physical | | Elasticity | | Poisson's | expansion CTE |
| property | Material | modulus | | ratio | (ppm/° C.) |
| POF | POF | 3 | GPa | 0.4 | 66 |
| Covering | Ionomer resin | 160 | MPa | 0.4 | 120 |
| layer | | | | | |
| Tensile | Aramid fiber | 72 | MPa | 0.3 | 0 |
| strength | | | | | |
| fiber | | | | | |
| Connector | Polyphenylene | 83 | MPa | 0.4 | 26 |
| | sulfide resin | | | | |
| Housing | Zn/Al alloy | 70.7 | GPa | 0.3 | 24 |
| Resin (1) | Silicone resin | 9 | MPa | 0.4 | 153 |
| Resin (2) | Epoxy resin | 3 | GPa | 0.4 | 40 |
| Resin (3) | Acrylic resin | 2 | GPa | 0.4 | 60 |

In TABLE 1, the POF is mainly made of Xylex resin, and the coefficient of linear expansion (referred to hereinafter as “CTE” in some cases) is measured by a PVT test system (available from Toyo Seiki Seisaku-sho, Ltd.).

Using the analytical model, PVT measurements were performed based on the following test items and method.

### <Pressure-Specific Volume-Temperature (PVT) Test>

Pre-drying: Dried at 100° C. for at least 10 hours, and the measurements started within 15 minutes after taking out.
Test Device: PVT test system (available from Toyo Seiki Seisaku-sho, Ltd.).
Measurement mode: Low pressure temperature change mode.
Amount of sample: 1 to 1.5 g.
Temperature range: Starting temperature of 250° C. to ending temperature of 50° C. (at measurement intervals of 5° C.).
Pressure: 50 MPa, 40 MPa, 30 MPa, and 20 MPa.

An advanced nonlinear simulation solution (Marc available from Hexagon AB) was used for the analysis. For stress values, the stress applied to the POFs 9 when the temperature was increased from 25° C. to 80° C. was calculated in a manner to be described below.

Specifically, the solution was obtained by the finite element method using three expressions: an expression of equilibrium of forces, a relational expression between displacement and strain, and a relational expression between strain and stress (constitutive equation of material). First, displacement and strain were determined from the expression of equilibrium of forces and the relational expression between displacement and strain, and stress was calculated from the relational expression between strain and stress (constitutive equation of material).

### Experimental Examples 1 to 4

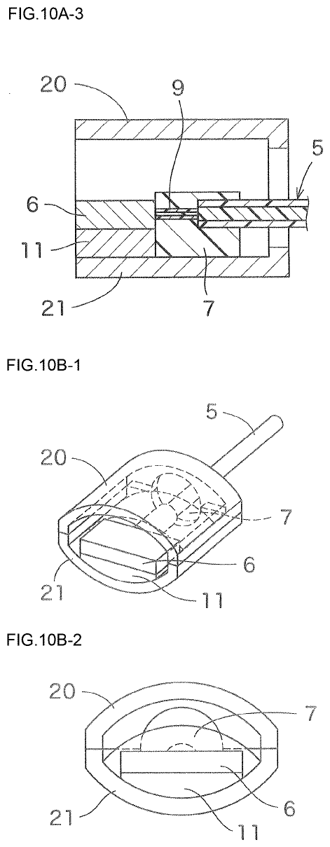

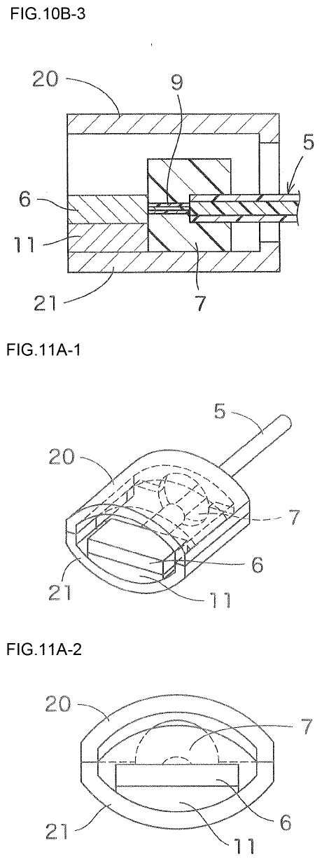

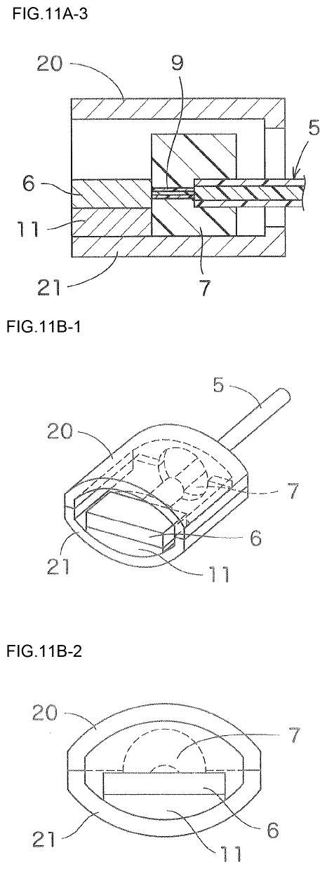

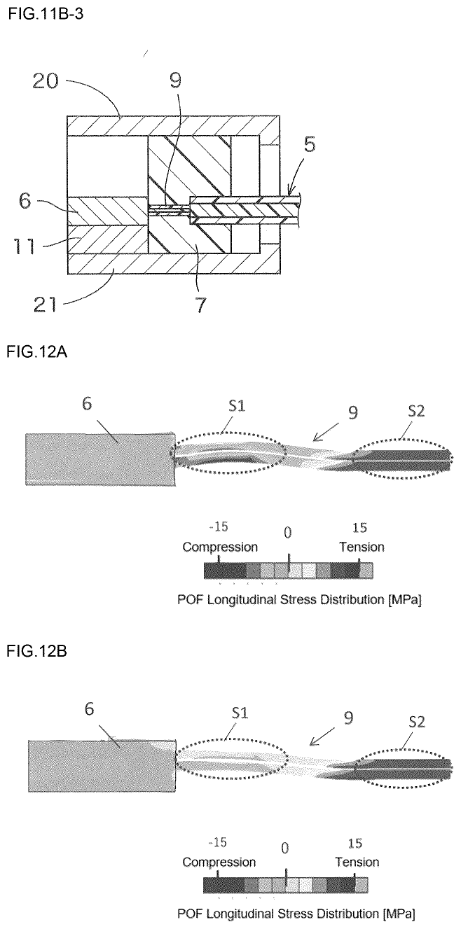

For investigation of the amounts of deformation of the POFs 9 depending on different dispositions of the resin 7, analytical models (Experimental Examples 1 to 4) were created using silicone resin as the resin 7, with the disposition of the resin 7 changed in a manner to be described below.
Experimental Example 1: Silicone resin was disposed in the position of the resin 7 shown in FIGS. 10A-1 to 10A-3 (in a lower portion only).
Experimental Example 2: Silicone resin was disposed in the position of the resin 7 shown in FIGS. 10B-1 to 10B-3 (the same amount in upper and lower portions).
Experimental Example 3: Silicone resin was disposed in the position of the resin 7 shown in FIGS. 11A-1 to 11A-3 (more resin in the upper portion).
Experimental Example 4: Silicone resin was disposed in the position of the resin 7 shown in FIGS. 11B-1 to 11B-3 (filled).

The results showed that the amounts of deformation of the POFs 9 were almost the same in Experimental Examples 1 to 3. It will be understood that this is because a void is present between the resin 7 and the upper housing 20 in each of Experimental Examples 1 to 3, so that the resin 7 expands toward the void under high-temperature conditions.

In Experimental Example 4, on the other hand, it will be understood that no voids are present between the resin 7 and the upper housing 20, so that the expansion of the resin 7 does not proceed in a specific direction but is suppressed.

From the results described above, it was found that disposing the resin 7 so that no voids were present between the resin 7 and the upper housing 20 was useful from the viewpoint of preventing cracking in the POFs 9. On the other hand, if the resin 7 is disposed so that no voids are present between the resin 7 and the upper housing 20, there is a likelihood that the upper housing 20 is damaged by the force of expansion, if any, of the resin 7 under high-temperature conditions.

For this reason, further investigation was made as to whether there was any other method to suppress the deformation of the POFs 9 than disposing the resin 7 so that no voids were present between the resin 7 and the upper housing 20.

### Experimental Examples 5 and 6

For investigation of the amounts of deformation of the POFs 9 depending on different types of resin 7, an analytical model (Experimental Example 5) with a different type of resin 7 from Experimental Example 1 and an analytical model (Experimental Example 6) with a different type of resin 7 and different disposition of the resin 7 from Experimental Example 1 were created.
Experimental Example 5: Epoxy resin was disposed in the position of the resin 7 shown in FIGS. 10A-1 to 10A-3 (in a lower portion only).
Experimental Example 6: Epoxy resin was disposed in the position of the resin 7 shown in FIGS. 11B-1 to 11B-3 (filled).

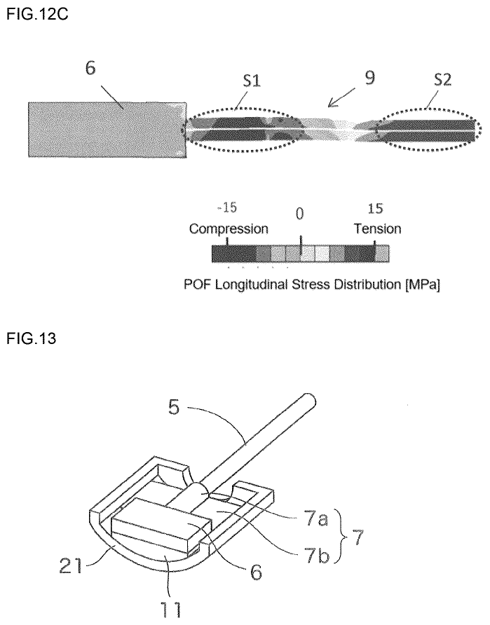

The deformation and stress distribution of the POFs 9 were calculated in the same manner as in Experimental Examples 1 to 4. The results are shown in FIGS. 12A to 12C together with the results of Experimental Example 1.

FIG. 12A shows the results of Experimental Example 1. FIG. 12B shows the results of Experimental Example 5. FIG. 12C shows the results of Experimental Example 6.

The results of FIGS. 12A to 12C showed that the POFs 9 were significantly deformed in a location where the POFs 9 were in contact with the resin 7 in Experimental Example 1 (FIG. 12A), whereas the deformation of the POFs 9 was suppressed in a location where the POFs 9 were in contact with the resin 7 in Experimental Example 5 (FIG. 12B). As shown in FIGS. 12A to 12C (especially FIG. 12A), part of the POFs 9 which was near the connector 6 (i.e., a bare portion of the POFs 9 shown enclosed by broken lines S1 in FIGS. 12A to 12C) was in a compressed state, although there were differences in strength. Part of the POFs 9 which was far from the connector 6 (shown enclosed by broken lines S2 in FIGS. 12A to 12C) was in tension, although there were differences in strength.

In Experimental Example 6 (FIG. 12C), the POFs 9 were subjected to compressive stress although the deformation of the POFs 9 was suppressed in a location where the POFs 9 were in contact with the resin 7.

### Experimental Examples 7 and 8

In addition, analytical models with different types of resin 7 (Experimental Examples 7 and 8) were created.
Experimental Example 7: Acrylic resin was disposed in the position of the resin 7 shown in FIGS. 10A-1 to 10A-3 (in a lower portion only).
Experimental Example 8: Epoxy resin was disposed in the position of the resin 7 shown in FIGS. 10A-1 to 10A-3 after the POFs 9 were covered with acrylic resin (acrylic+epoxy).

FIG. 13 shows the resin 7 disposed in Experimental Example 8. In Experimental Example 8, acrylic resin is disposed in a portion designated by the reference character 7a (near the POFs 9), and epoxy resin is disposed in a portion designated by the reference character 7b. In FIG. 13, the upper housing 20 is not shown for the purpose of making the disposition of the resin 7 easy to see.

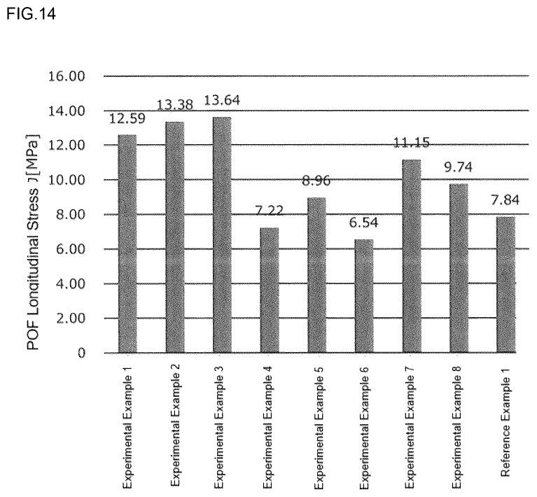

The longitudinal stress of the POFs 9 (referred to hereinafter as “POF longitudinal stress” in some cases) was calculated for Experimental Examples 1 to 6 in addition to Experimental Examples 7 and 8. The results thereof are also shown in FIG. 14. An analytical model in which the resin 7 is not used is also shown in FIG. 14 (as Reference Example 1). Cracking in the POFs 9 has been observed to occur when the POFs 9 are subjected to stress in the vicinity of 14.22 MPa.

It is found from the results shown in FIG. 14 that the POF longitudinal stresses are different for different types of resin 7 even if the state of disposition of the resin 7 is the same (with reference to Experimental Examples 1, 5, 7, and 8).

In particular, when resins 7 with different coefficient of linear expansions are used, a contrast is found between Experimental Examples 5 and 8 in which the POFs 9 are subjected to the same stress as or lower stress than in Reference Example 1 which cannot be affected by the expansion of the resin 7; and Experimental Examples 1 and 7 in which the POFs 9 are subjected to stress close to the stress subjected at the time of the occurrence of cracking.

Based on this finding, a relationship between the coefficient of linear expansion of the resin 7 and the stress on the POFs 9 was investigated. Specifically, a relationship between the longitudinal stress on the lower surfaces of the POFs 9 and the distance from the connector 6 when the resins 7 with different coefficients of linear expansion were used was calculated using the advanced nonlinear simulation solution (Marc available from Hexagon AB).

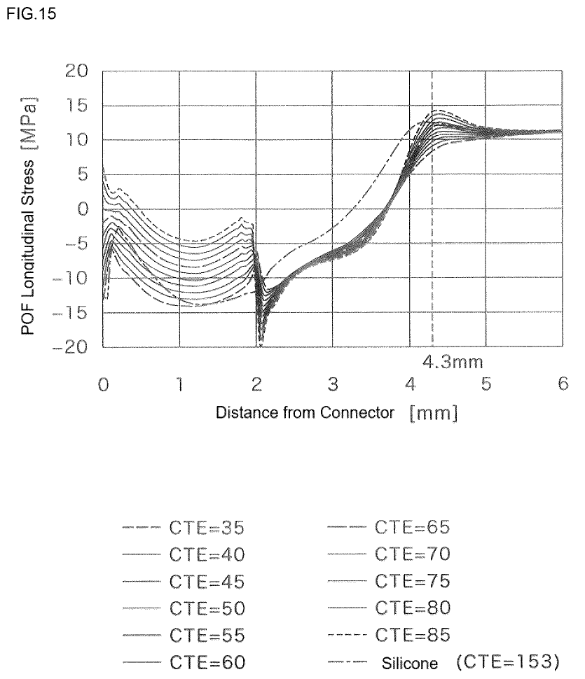

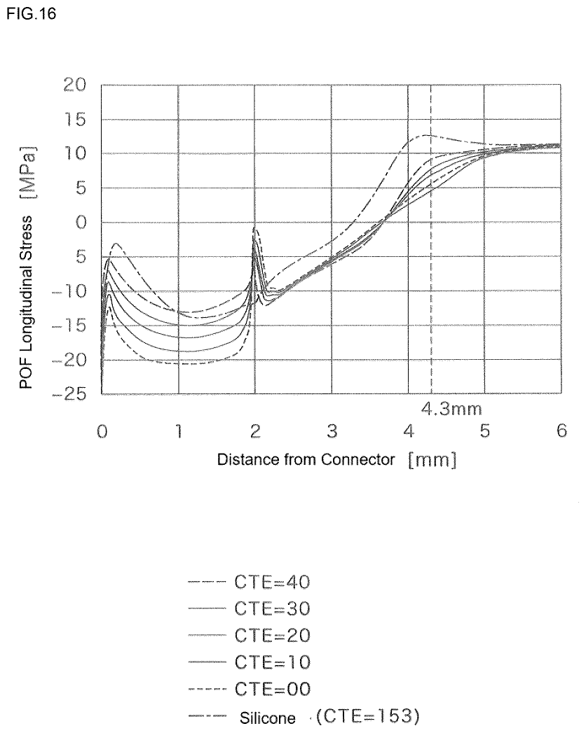

FIG. 15 shows the results obtained when coefficients of linear expansion of the resin 7 are 35 to 85. FIG. 16 shows the results obtained when coefficients of linear expansion of the resin 7 are 0 to 40. The results obtained when silicone resin (a coefficient of linear expansion of 153) was used is also shown in FIGS. 15 and 16.

Based on these results, the POF longitudinal stress on the lower surface of the POFs 9 at a distance of 4.3 mm from the connector 6 where the stress is the highest is also shown in FIG. 17 versus different coefficients of linear expansion. In FIG. 17, the POF longitudinal stress of 12.6 MPa obtained when silicone resin (a coefficient of linear expansion of 153) was used is shown in a broken line Q. Resins having a POF longitudinal stress lower than this broken line Q are preferably used as the resin 7 of the present disclosure.

On the other hand, a force which tends to expand the POFs 9 in the longitudinal direction (Y direction) as the temperature increases is generated in the bare portion of the POFs 9 (a first end region of an optical cord end portion). However, the expansion of the POFs 9 is suppressed near the portion thereof fixed by the connection to the connector 6, so that compressive stress is generated. This is more pronounced as the coefficient of linear expansion of the resin 7 is lowered.

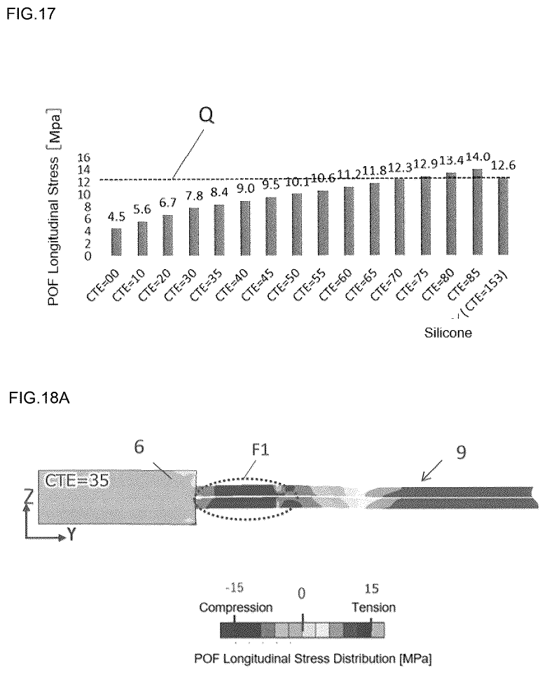

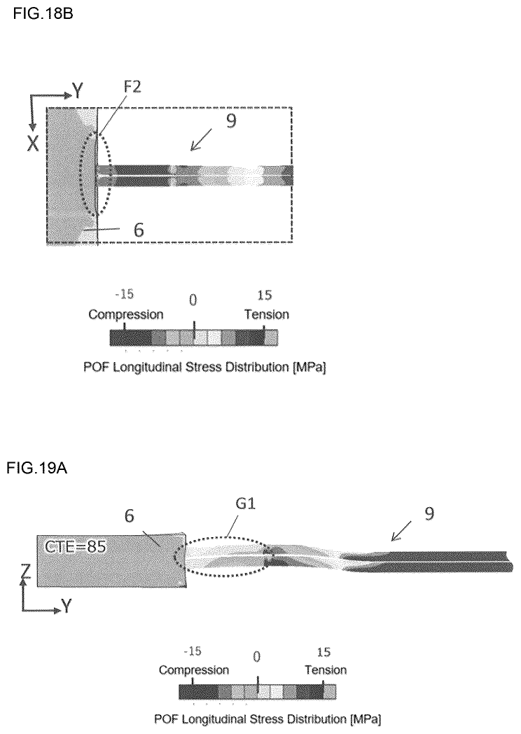

FIGS. 18A and 18B show the POF longitudinal stress applied to the POFs 9 and the connector 6 when the coefficient of linear expansion of the resin 7 is 35. As indicated in an area enclosed by a broken line F1 in FIG. 18A which is a side view, compressive stress is generated in the POFs 9 near the connector 6. At this time, no deformation of the connector 6 is found as indicated in an area enclosed by a broken line F2 in FIG. 18B which is a top view.

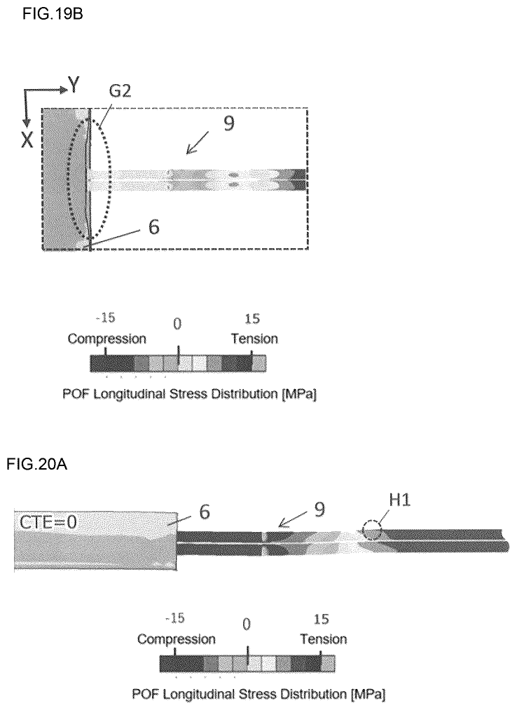

FIGS. 19A and 19B show the POF longitudinal stress applied to the POFs 9 and the connector 6 when the coefficient of linear expansion of the resin 7 is 85. As the coefficient of linear expansion of the resin 7 increases, the POFs 9 are pressed upwardly by the expansion of the resin 7, as indicated in an area enclosed by a broken line G1 in FIG. 19A which is a side view. In addition, the connector 6 is pressed and deformed by the thermal expansion of the resin 7, as indicated in an area enclosed by a broken line G2 in FIG. 19B which is a top view.

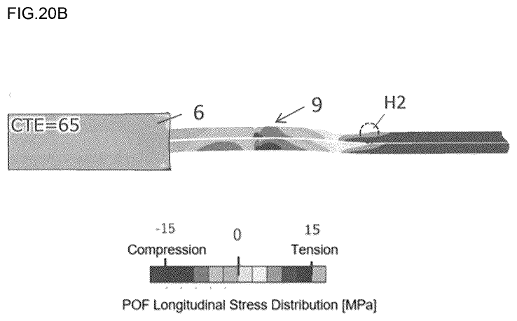

Further, an instance in which the coefficient of linear expansion of the resin 7 is made smaller will also be investigated. FIG. 20A shows the POF longitudinal stress applied to the POFs 9 and the connector 6 when the coefficient of linear expansion of the resin 7 is 0, as seen in a lateral direction. In an area enclosed by a broken line H1 in FIG. 20A, the stress on the upper surface of the POFs 9 tended to increase.

This tendency is apparent by contrast with FIG. 20B showing the POF longitudinal stress applied to the POFs 9 and the connector 6 when the coefficient of linear expansion of the resin 7 is 65, as seen in a lateral direction.

That is, in an area enclosed by a broken line H2 in FIG. 20B, there is no tendency for the POF longitudinal stress to increase on the upper surface of the POFs 9 as in the area enclosed by the broken line H1 in FIG. 20A.

Based on this finding, a relationship between the coefficient of linear expansion of the resin 7 and the POF longitudinal stress on the upper surface of the POFs 9 was also investigated.

Specifically, a relationship between the POF longitudinal stress on the upper surface of the POFs 9 and the distance from the connector 6 when the resins with different coefficients of linear expansion were used as the resin 7 was investigated using the advanced nonlinear simulation solution (Marc available from Hexagon AB).

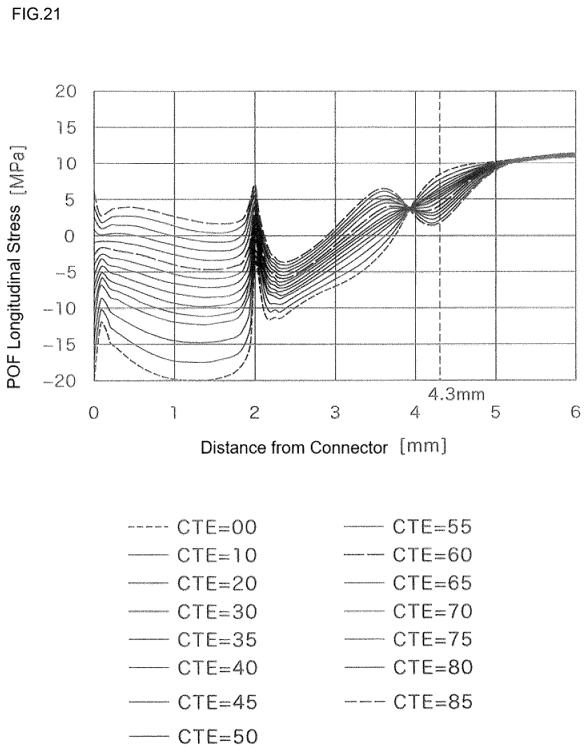

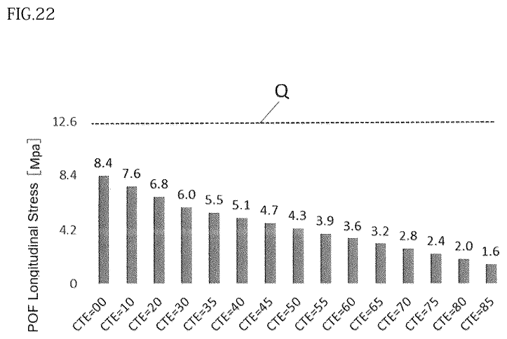

The results are shown in FIG. 21. Based on these results, the POF longitudinal stress on the upper surface of the POFs 9 at a distance of 4.3 mm from the connector 6 where the stress is the highest is also shown in FIG. 22 versus different coefficients of linear expansion.

In FIG. 22, the POF longitudinal stress of 12.6 MPa obtained when silicone resin (a coefficient of linear expansion of 153) was used is shown in the broken line Q. Resins having a POF longitudinal stress lower than this broken line Q are preferably used as the resin 7 of the present disclosure. However, all of the resins have the POF longitudinal stress lower than this broken line Q. It can be understood that the low coefficient of linear expansion of the resin 7 is not a problem in terms of the stress on the upper surface.

The results of these experimental examples showed that the occurrence of cracking in the POFs 9 under high-temperature and/or high-humidity conditions was suppressed when the coefficient of linear expansion of the resin 7 and the coefficient of linear expansion of the POFs 9 satisfied certain conditions, regardless of the state of disposition of the resin 7.

Although specific forms in the present disclosure have been described in the examples, the examples should be considered as merely illustrative and not restrictive. It is contemplated that various modifications evident to those skilled in the art could be made without departing from the scope of the present disclosure.

The optical communication cable of the present disclosure is usable as an optical communication cable that suppresses the occurrence of cracking in POFs and have excellent durability under high-temperature and/or high-humidity conditions.
1 Opto-electric compound transmission module
2 Hybrid cable
3 First housing
4 Second housing
5 Optical cord
6 Connector
7 Resin
8 Covering layer
9 Plastic optical fibers (POFs)
10 Tensile strength fiber
11 Pedestal
12 Adhesive layer
13 Optical communication cable
14 Plug
15 Photoelectric conversion part
19 Case
20 Upper housing
21 Lower housing
E Tip portion of plastic optical fibers
R End portion of optical cord for connection to connector
r1 First end region where plastic optical fibers are exposed
r2 Second end region where plastic optical fibers are not exposed

1. An optical communication cable comprising:
an optical cord including a plastic optical fiber and a covering layer provided around the plastic optical fiber;
a connector for connection to the plastic optical fiber of the optical cord;
a first housing disposed on a first surface side of the connector;
a second housing disposed on a second surface side of the connector; and
a resin for fixing the optical cord in a case formed by combining the first housing and the second housing,
wherein an end portion of the optical cord for connection to the connector has a first end region where the covering layer is not formed and the plastic optical fiber is exposed, and a second end region where the covering layer is formed and the plastic optical fiber is not exposed,
wherein a tip portion of the plastic optical fiber in the first end region is connected to the connector,
wherein the resin is disposed so as to be in contact with the end portion of the optical cord and the second housing, and
wherein Expression (1) is satisfied:
$$t 1 \leq t 2 + 5 \qquad ( 1 )$$
where t1 is the coefficient of linear expansion of the resin and t2 is the coefficient of linear expansion of the plastic optical fiber.

2. The optical communication cable according to claim 1,
wherein the coefficient of linear expansion of the plastic optical fiber is in the range of 50 to 80 ppm/° C.

3. The optical communication cable according to claim 1,
wherein the resin is disposed so as to be also in contact with the first housing.

4. The optical communication cable according to claim 1,
wherein the resin is a resin having an epoxy group.

5. The optical communication cable according to claim 1,
wherein the end portion of the optical cord has a length in the range of 4 to 8 mm.

6. The optical communication cable according to claim 1,
wherein the first end region of the end portion of the optical cord has a length in the range of 1 to 4 mm.

7. The optical communication cable according to claim 1,
wherein the resin is disposed so as to be also in contact with the first surface of the connector, and
wherein a pedestal for fixing the position of the connector is provided between the second housing and the connector.

8. The optical communication cable according to claim 2,
wherein the resin is disposed so as to be also in contact with the first housing.

9. The optical communication cable according to claim 2,
wherein the resin is a resin having an epoxy group.

10. The optical communication cable according to claim 2,
wherein the end portion of the optical cord has a length in the range of 4 to 8 mm.

11. The optical communication cable according to claim 2,
wherein the first end region of the end portion of the optical cord has a length in the range of 1 to 4 mm.

12. The optical communication cable according to claim 2,
wherein the resin is disposed so as to be also in contact with the first surface of the connector, and
wherein a pedestal for fixing the position of the connector is provided between the second housing and the connector.
